(19) United States
(12) Patent Application Publication
(10) Pub. No.: US 2008/0126289 A1
(43) Pub. Date: May 29, 2008

(54) Apparatus and method for assisting knowledge circulation

(75) Inventors: Akihiko Obata, Kawasaki (JP); Shigeru Yamada, Kawasaki (JP); Hiroaki Harada, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,824

(22) Filed: Aug. 28, 2007

(30) Foreign Application Priority Data
Nov. 28, 2006 (JP) 2006-319940

(51) Int. Cl. G06N 5/02

(52) U.S. Cl. 706/50

(57) ABSTRACT

An apparatus registers a participant instance with an incentive inputted by a member “a” (a participant), a searcher instance as supplement to the participant instance inputted by a member “b” (a searcher), and an approval incentive added by a member “c” (an approver) in an instance database 11. Then, when a solver “d” who viewed the participant instance and proposed a solution requests display of incentive allocation, the apparatus sums up the incentive for the participant instance from the instance database 11 and the approval incentive to calculate incentive allocation between the searcher of the associated searcher instance and the solver based on a pre-determined rate. The apparatus further weights, using pre-determined rate, on the allocation to the searcher of searcher instance referenced by others. The apparatus displays the calculated incentive allocation on a terminal 2d of the solver “d”.

### CROSS-REFERENCE TO RELATED APPLICATIONS

This application claims priority from Japanese patent application Serial no. 2000-123456 filed Month Day, 2000, the contents of which are incorporated by reference herein.

### BACKGROUND OF THE INVENTION

1. Field of the Invention

The present invention relates to a data processing technique for assisting knowledge circulation. More particularly, the present invention relates to a data processing technique to facilitate circulation of information accumulated such as in a knowledge management system or a knowledge base and shared as knowledge.

2. Description of the Related Art

The knowledge management is known for accumulating knowledge within a particular department or of individuals in a database and using the knowledge database by pre-determined members to share the knowledge retained by the individual members as knowledge among the entire organization. The knowledge management makes a database of latent experiences or knowledge among an organization such as a past failure instance or a personal idea in a business field. The knowledge management technique is therefore expected to be an approach that brings better business result, by utilizing the database, to activate a project or improve efficiency of the project.

It is important that large amount of knowledge data has been accumulated in a knowledge database (knowledge base) for a knowledge management system to produce its effect. For this purpose, a mechanism is necessary for system users to actively register their knowledge or information on the database. However, if there is no personal and direct benefit to users who registered their knowledge or information, they would be reluctant to register actively their failure experiences or knowledge on a knowledge base.

In view of the above situation, a conventional knowledge management system employs a mechanism to provide an incentive to a register (user) on the basis of frequency of use of register's information by other users. That encourages users to register their useful information.

There is also a known system for publishing accumulated problems consulted and advertising for collection ideas that may solve the problems from the public. The system previously presents a reward based on points to be provided to a person presenting an idea for solution in order to encourage people to submit ideas (for example, refer to Japanese Patent Publication No. 2006-99418).

However, according to the method of providing an incentive based on frequency in use of knowledge, which is employed in the conventional knowledge management system, users cannot know how much incentive they will get before registering their information. This causes a problem in that users will not register information actively. Particularly, if a uniform incentive is provided regardless of information content, the incentive does not encourage users to register useful information. Particularly, there is a problem in that users do not register information or known instances, what is termed “implicit knowledge”, which the users do not aware of as problems.

The above-mentioned system, which registers and publishes a problem or an instance to be solved in order to call for its solution proposals, provides a mechanism for previously informing an incentive in order to encourage a person who may have an idea to solve the problem to present his idea. According to the system, although another person who bears a problem same as or similar to the registered problem or instance desires to encourage people to actively present solution proposals by raising the incentive, the person cannot raise the incentive.

In the above system, if an instance having ambiguous description of a problem has been registered, detailed or supplementary information needs to be provided to clarify the problem to call for relevant solution proposals to the registered problem. However, a person who has “implicit knowledge” as the supplementary information cannot get an incentive to be provided for the problem or instance. The system cannot encourage such a person to register useful information like such “implicit knowledge”.

In addition to the above mentioned system, a mechanism is desired that relevantly allocates incentives depending on the extent of contribution to solution when a plurality of persons are involved in the solution to a registered problem or instance.

### SUMMARY OF THE INVENTION

The present invention aims to assist information circulation on a knowledge database with which members share registered information as their knowledge.

To achieve the aim, the present invention is to provide an apparatus and a method for assisting knowledge circulation to allocate incentives to members involved in solution to an instance registered in the knowledge database by considering the extent of contribution to the solution.

The apparatus according to the present invention comprises processing units described below to assist the information circulation by the knowledge database with which pre-determined members share registered information as their knowledge.

In the apparatus according to the present invention, when an instance (referred to as a “participant instance”) of a problem to be solved that is described by a member is inputted, a participant instance registering unit registers data including the participant instance indicating the problem for which solution proposals are sought, an incentive to be provided to members who are involved in solution to the participant instance, and the member (referred to as a “participant”), who registered the participant instance in the knowledge database. When another member views the participant instance in the knowledge database and inputs information such as detailed material or supplementary material (referred to as a “searcher instance”) for the participant instance, a searcher instance registering unit associates data including the searcher instance and a member (referred to as a “searcher”) who registered the searcher instance regarding the participant instance and registers the data in the knowledge database.

Then, the other member views the participant instance in the knowledge database to think of solution proposals, and desires to confirm an incentive for solution. When the member requests to display incentive allocation, an allocation calculating unit retrieves the incentive to be provided for the participant instance and associated searchers from the knowledge database. The calculating unit calculates allocation of the incentive to each of the members based on a pre-determined allocation rate. An incentive display unit displays the incentive allocation to the searchers of searcher instances and a member (referred to as a “solver”) who registered a solution proposal associated with the participant instance on the requesting person's display device or the like.

According to the present invention, in the case of unclear or insufficient description of a participant instance registered in the knowledge database, members having specific instances or referential material for the participant instance can get incentives if they register their information (searcher instances) in the knowledge database. This enables to provide an incentive to encourage a member to register the member's information being “implicit knowledge” contributing to solution to a participant instance in order to detail and clarify a problem in the participant instance.

An approver registering unit in the apparatus can register as an approver a member (referred to as a “approver”) who approves the participant instance and an approval incentive to be added to the incentive for the participant instance in the knowledge database when the member approving the participant instance registered in the knowledge database inputs the additional incentive to facilitate proposal of solutions.

An allocation calculating unit can sum up the incentive and the approval incentive for the participant instance and calculate allocation of the total incentive.

The apparatus according to the present invention allows raising an incentive to be provided for the registered participant instance after the registration of the instance. This allows for members other than the participant to use the added incentive to encourage other members to propose solutions. The members can also raise the incentive after the registration of the participant instance. The raised incentive indicates increase of importance of the participant instance and may encourage members to propose solutions.

The searcher instance registering unit can also register reference relation which indicates the searcher instance referenced by other members in the knowledge database. The allocation calculating unit also identifies reference relations of the searcher instances associated with the participant instance. Based on the identified reference relations, the allocation calculating unit weights incentives to be allocated to searchers and calculates, by increasing the incentives by a pre-determined rate, the allocation to the searchers who registered the referenced searcher.

In this way, an incentive can be allocated more relevantly to the member who registered the searcher instance viewed by other members in registration of other searcher instances or an approval incentive and proposal of solutions by considering larger contribution to the solution than other members.

The apparatus can also display the incentive allocation to one or more members (a searcher and/or a solver) involved in the solution to the registered participant instance if the member requests. Consequently, members can confirm an incentive to be allocated before registering information. This encourages the members to actively register information.

A contact processing unit stores members' contact information. The contact processing unit can send a pre-determined message to a member to whom contact is requested by another member.

This allows a member who reviewed a proposed solution to the participant instance to contact the member as the participant member and one or more members as an approver to present another solution proposal or discuss the proposed solution.

As described above, according to the present invention, incentives are allocated not only to a member who directly contributed to a solution to a participant instance registered in a knowledge database by proposing the solution but also to other members who indirectly contributed to the solution by detailing or clarifying contents of the instance. The incentives are also allocated by considering the contribution by a member who registered information referenced by other members. Therefore, incentives can be allocated more relevantly than by the prior arts, enabling to facilitate information circulation such as registration and viewing of usable information in a knowledge database for active use of the knowledge database.

### BRIEF DESCRIPTION OF THE DRAWINGS

FIG. 1 is a drawing showing an example of configuration in the preferable embodiment of the present invention;

FIGS. 2A, 2B, 2C and 2D are drawings showing examples of data structures in an instance database;

FIG. 3 is a flow diagram illustrating a process to register a participant instance;

FIG. 4 is a flow diagram illustrating a process to register searcher instances;

FIG. 5 is a flow diagram illustrating a process to raise incentives;

FIG. 6 is a flow diagram illustrating a process to display incentive allocation;

FIG. 7 is a diagram showing an example of data inputted as a participant instance, searcher instances, approvers and a solver;

FIG. 8 is a diagram showing viewing relations (reference relations) among data inputted as the participant instance, the searcher instances, the approvers and the solver;

FIG. 9 is a diagram showing an example of a screen display for the participant instance;

FIG. 10 is a diagram showing an example of a screen display for the participant instance with a registered searcher instance;

FIG. 11 is a diagram showing an example of a screen display for the searcher instance;

FIG. 12 is a diagram showing an example of a screen display for the participant instance with registered searcher instances and approvers; and

FIG. 13 is a diagram showing an example of a screen display of incentive allocation.

### DETAILED DESCRIPTION OF THE PREFERRED EMBODIMENTS

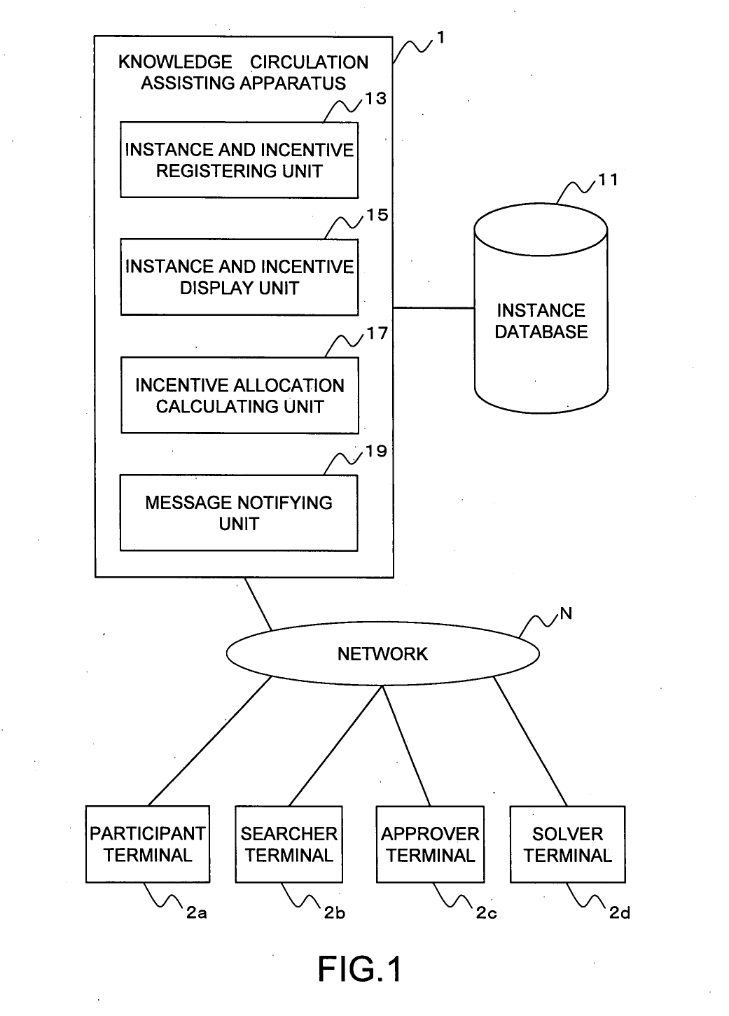

FIG. 1 illustrates a drawing showing a configuration example in the best embodiment of the present invention.

A knowledge circulation assisting apparatus 1 is a computer comprising a CPU and a memory. The apparatus 1 also comprises an instance and incentive registering unit 13 composed of a software program or the like, an instance and incentive display unit 15, an incentive allocation calculating unit 17 and a message notifying unit 19. The knowledge circulation assisting apparatus 1 connects to an instance database 11 to read out/write data from/in the database 11.

The instance database 11 can be registered on or referred to information by pre-determined members. In this embodiment, the instance database 11 stores and manages information of business-related instances shared by members belonging to a certain organization.

The knowledge circulation assisting apparatus 1 transmits data with terminals 2 as computers used by the pre-determined members via a network N. In this embodiment, the member terminals 2 are a terminal 2a of a participant member “a” who registered a participant instance being a problem for which solution proposals are sought, a terminal 2b of a searcher “b” who registered a searcher instance being supplementary information to the participant instance registered by member “a”, a terminal 2c of an approver “c” who approved the participant instance and added an approval incentive, and a terminal 2d of a solver “d” who thought of a solution proposal to the participant instance.

The instance and incentive registering unit 13 in the knowledge circulation assisting apparatus 1 registers data in the instance database 11. The data includes a participant instance inputted through the terminal 2a of the participant “a”, a searcher instance inputted through the terminal 2b of the searcher “b”, and an approver inputted through the terminal 2c of the approver “c”. The instance and incentive registering unit 13 also registers a reference relation indicating a searcher instance in the instance database 11 viewed by other members.

The instance and incentive display unit 15 displays participant instances, searcher instances, approvers, allocation of incentives to members involved in solution or the like registered in the instance database 11 on the member terminals 2 (2a, 2b, 2c and 2d).

The incentive allocation calculating unit 17 sums up an incentive for a participant instance and approval incentives from the instance database 11, retrieves searchers associated with the participant instance, and calculates incentive allocation to the searchers and a solver based on a pre-determined rate.

The incentive allocation calculating unit 17 identifies reference relations of searcher instances associated with the participant instance from the instance database 11. Based on the reference relations, the incentive allocation calculating unit 17 weights the incentive allocation rate, and calculates an incentive to be allocated to searchers of a referenced searcher instance by increasing the incentive depending on the weighting.

The message notifying unit 19 sends pre-determined messages to relevant members when a contact request is selected in the instance and incentive display unit 15 through the terminal 2.

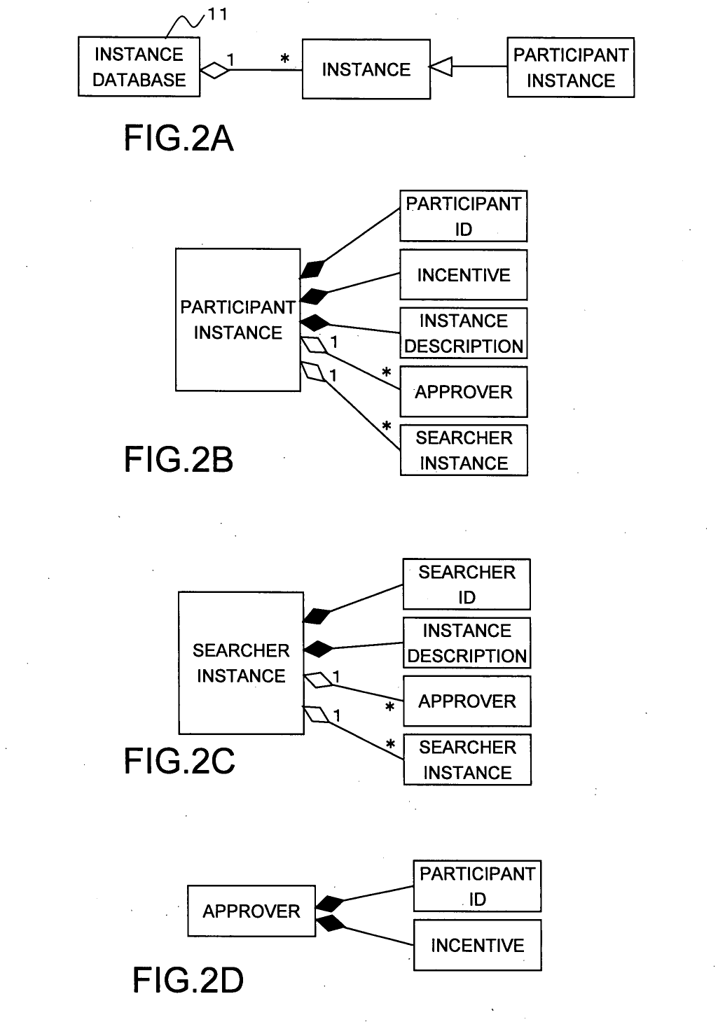

FIG. 2 illustrates a drawing showing examples of data structures in the instance database 11. FIG. 2A shows an example of data configuration of the instance database. The instance database 11 contains a plurality of instances. An instance is composed of a specific participant instance.

FIG. 2B illustrates an example of configuration of participant instance data. A participant instance is instance data relating to a problem which a solution is sought for. Participant instance data is composed of a participant ID, an incentive, instance description, approvers and searcher instances. A participant ID is data to identify a member (a participant member) who registered the participant instance. An incentive is data of the amount of a reward to be provided to members involved in solution to the participant instance. In this embodiment, the incentive is points exchangeable such as for pre-determined articles or services. Members involved in solution to a participant instance herein are a member (a solver) who proposed a solution to the participant instance and one or more members (searchers) who registered searcher instances. Instance description is data such as sentences or associated diagrams describing a problem which solution proposals are sought for. An approver is information to identify a member, as an approver, who approved the participant instance and provided an additional incentive for the participant instance. A searcher instance is instance data indicating such as detailed material or reference instances to supplement contents of the participant instance registered by a member who viewed the participant instance. Participant instance data may include zero, one or a plurality of approvers or zero, one or a plurality of searcher instances for the participant instance.

FIG. 2C shows an example of configuration of searcher instance data. Searcher instance data is composed of a searcher ID, instance description, approvers and searcher instances. A searcher ID is data to identify a member as a searcher. Instance description is data such as sentences or associated diagrams describing the searcher instance. Searcher instance data may include zero, one or a plurality of approvers or zero, one or a plurality of other searcher instances for the searcher instance.

FIG. 2D shows an example of configuration of approver data. Approver data is composed of a participant ID and an incentive. A participant ID is data of a participant ID of a participant instance approved by an approver. An incentive (an approval incentive) is data of an incentive provided in addition to an incentive provided by a participant member.

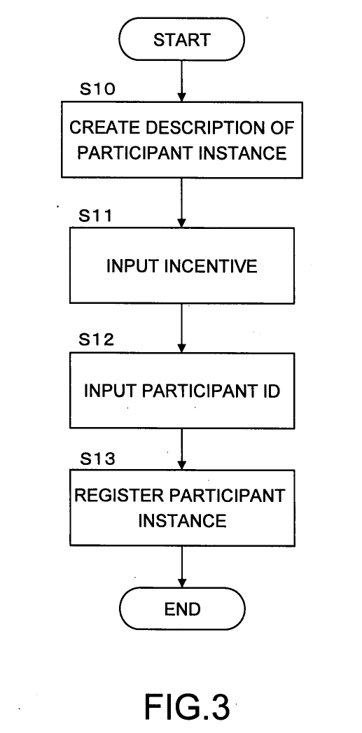

FIG. 3 shows a flow diagram illustrating a process to register a participant instance. Instance description is created that describe content of a participant instance through the terminal 2a of the participant “a” (step S10). An incentive is inputted to be provided to members involved in solution (step S11). A member ID of the participant “a” (a participant ID) is inputted (step S12).

The instance and incentive registering unit 13 in the knowledge circulation assisting apparatus 1 registers data such as the instance description, the incentive or the participant ID received via the network N in the instance database 11 as a participant instance (step S13).

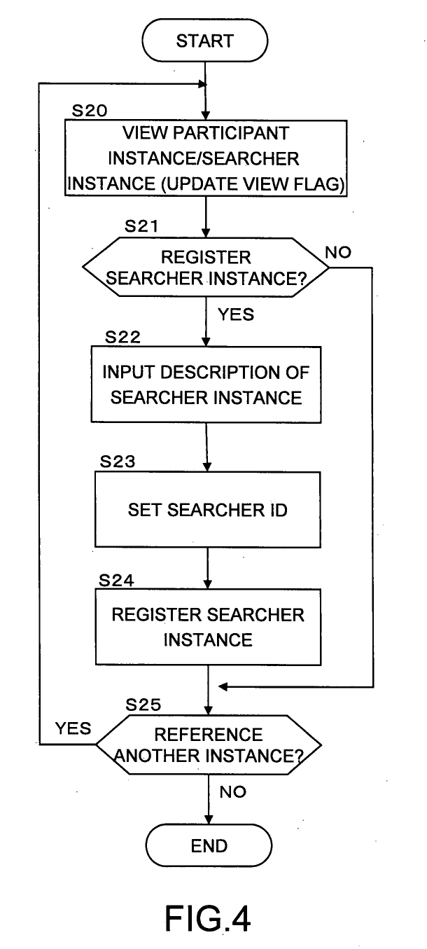

FIG. 4 shows a flow diagram illustrating a process to register a searcher instance. Any of participant instances or searcher instances accumulated in the instance database 11 is viewed through the terminal 2b of the searcher “b”. The instance and incentive registering unit 13 updates a view flag for the viewed participant instance or searcher instance (step S20). Then, if a register process of a searcher instance is selected for the viewed participant instance or searcher instance through the terminal 2b of the searcher “b” (YES at step S21), instance description in the searcher instance are created (step S22). A member ID of the searcher “b” (a searcher ID) is inputted (step S23). The instance and incentive registering unit 13 in the knowledge circulation assisting apparatus 1 associates data as the searcher instance with the viewed participant instance or searcher instance; the data includes the instance description or the searcher ID in the searcher instance received via the network N. Then, the unit 13 registers the data in the instance database 11 (step S24).

Then, if another participant instance or searcher instance is viewed (YES at step S25), the process returns to the processing at step S20. On the other hand, if another participant instance or searcher instance is not viewed (NO at step S25), the process ends.

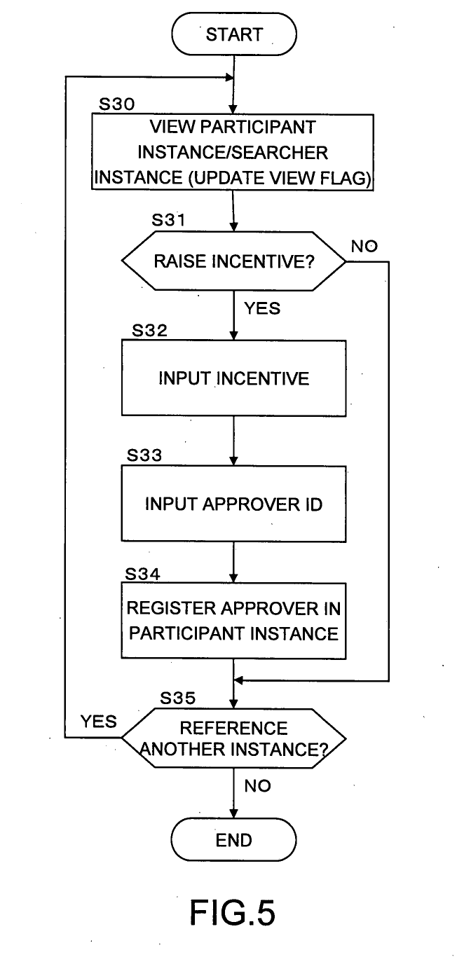

FIG. 5 is a flow diagram illustrating a process to raise an incentive. Any of the participant instances or searcher instances accumulated in the instance database 11 is viewed through the terminal 2c of the approving member “c”. The instance and incentive registering unit 13 updates a view flag for the viewed participant instance or searcher instance (step S30).

If an incentive raising process of a searcher instance is selected for the viewed participant instance or searcher instance through the terminal 2c of the approving member “c” (YES at step S31), an approval incentive is inputted (step S32). A member ID of the approving member “c” (an approver ID) is inputted (step S33). The instance and incentive registering unit 13 in the knowledge circulation assisting apparatus 1 associates data as the approver data with the viewed participant instance or searcher instance; the data includes the instance description or the approver ID received via the network N. Then, the unit 13 registers the data in the instance database 11 (step S34).

Then, if another participant instance or searcher instance is viewed (YES at step S35), the process returns to the processing at step S30. On the other hand, if another participant instance or searcher instance is not viewed (NO at step S35), the process ends.

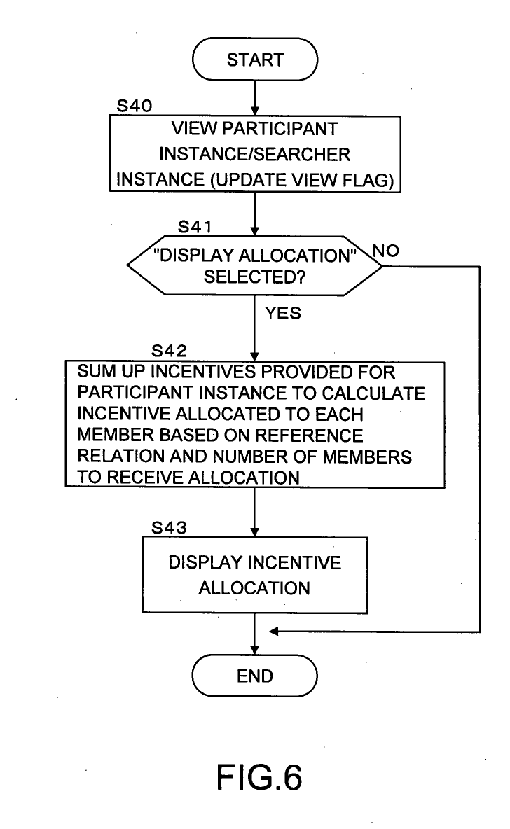

FIG. 6 is a flow diagram illustrating a process to display incentive allocation. Any of the participant instances or searcher instances accumulated in the instance database 11 is viewed through the terminal 2d of the solver “d”. The instance and incentive registering unit 13 updates a view flag for the viewed participant instance or searcher instance (step S40).

A process is selected for displaying allocation of an incentive for the viewed participant instance (YES at step S41). After the selection, the incentive allocation calculating unit 17 in the knowledge circulation assisting apparatus 1 sums up the incentive and the approval incentives for the viewed participant instance and counts the number of members to be allocated to (the number of searchers and solvers); then the unit 17 calculates the incentives to be allocated to the members based on the pre-determined rate (step S42). If any searcher instance is viewed by other members such as the searchers, the approvers or the solver, the incentive allocation calculating unit 17 calculates allocation to the searcher who registered the searcher instance by weighting based on reference relations of the searcher instance. Then, the terminal 2d displays the calculated incentive allocation (step S43) and the process ends.

The followings are specific examples of the processing of calculating incentive allocation at step S42.

(1) Incentive to a Solver
An incentive to be provided to a solver is allocated so as to be a pre-determined multiplier “a” of an incentive to a searcher:
searcher incentive=total incentive/(number of searchers+a)
solver incentive=searcher incentive*a

(2) Incentive for Approver Acquisition
Allocation of an incentive to a searcher is calculated by weighting a searcher of a searcher instance viewed by an assenter. The searcher of the searcher instance registered with associated approver ID is extracted. Then, an approval incentive for an approver is allocated to the extracted searcher. If an approver views a plurality of searcher instances, an approval incentive is allocated evenly among searchers of the plurality of searcher instances to be viewed. An incentive registered by a participant is allocated evenly among the searchers. This prevents an incentive to a searcher of a searcher instance viewed by no approver from being zero.

(3) Incentive for Searcher Acquisition
Allocation of an incentive for a searcher is calculated by weighting a searcher of a searcher instance viewed by another searcher. Searchers of the searcher instance who are associated with the searcher instance are extracted from the searcher instance registered in a participant instance. Then, an incentive weighted by, for example, a pre-determined multiplier “b” of the total of the above approver acquisition incentives in (2) is additionally provided to the extracted searchers.

(4) Incentive to a Searcher
Allocation of an incentive to a searcher is calculated by weighting a searcher of a searcher instance viewed by a solver. Searchers of some searcher instances referenced by the solver are extracted from all searcher instances. Then, an incentive weighted by, for example, a pre-determined multiplier “c” of the approver acquisition incentive in (2) is additionally provided to the extracted searchers.

The above multiplier values “a”, “b” and “c” can be set when a participant registers a participant instance. When a solution is proposed to the participant instance, an incentive is provided to relevant members based on allocation calculated by the incentive allocation calculating unit 17. Since incentive allocation and management processes are known in the art, the processes will not be described herein.

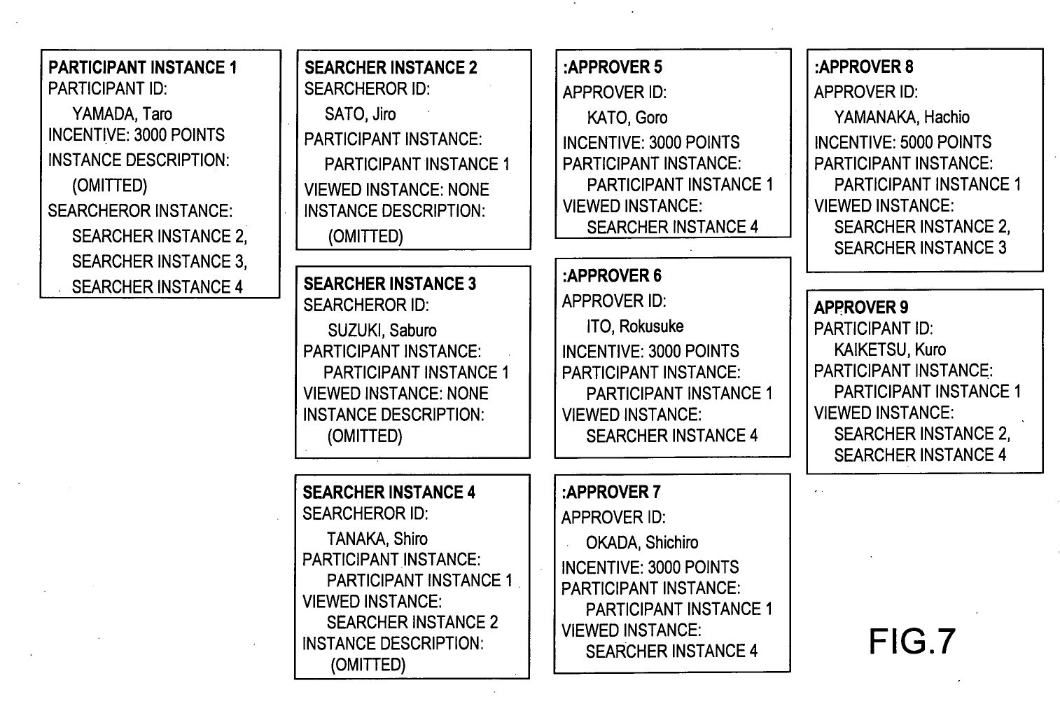

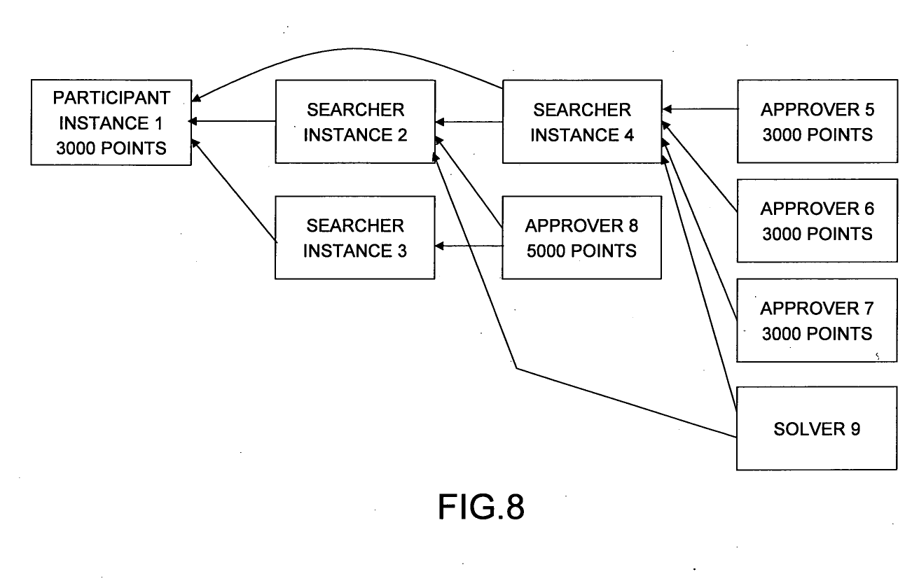

The followings are specific process examples in the present invention. FIG. 7 shows an example of data inputted as a participant instance, searcher instances, approvers and a solver in a specific example. FIG. 8 shows reference relations among the data.

When a member (Yamada, Taro; hereinafter referred to as a “participant 1”) registers an instance which solution proposals are sought for in the instance database 11, the following instance description and incentive for the participant instance are inputted through the terminal 2 of the participant 1. The inputted data is sent to the knowledge circulation assisting apparatus 1 via the network N so as to be registered in the instance database 11 as a participant instance “instance 1”.
“Instance description: Repetitive mistakes due to operation not according to operating procedure;
   Operators alternately executed operation according to the operating procedure for the system. Troubles occurred per month due to misunderstanding of contents written in the operating procedure, etc. . . . ;
   Incentive=3,000 points”

Afterward, another member (Sato, Jiro; hereinafter referred to as a “searcher 2”) views the “instance 1” and registers a searcher instance for the instance 1. The following instance description of the searcher instance is inputted through the terminal 2 of the searcher 2. The inputted data is registered in the instance database 11 as a searcher instance “instance 2” for the participant instance “instance 1”.
“Instance description: Interviewed ten operators;
   Interviewed ten operators for operating circumstances at that time with presenting manipulation log . . . ”

Afterward, another member (Suzuki, Saburo; hereinafter referred to as a “searcher 3”) views the participant instance “instance 1” only and registers his searcher instance “searcher instance 3” without viewing other searcher instances. Further, another member (Tanaka, Shiro) views the participant instance “instance 1” and the registered searcher instance 2 and registers a more detailed searcher instance” searcher instance 4”. Furthermore, three members (Kato, Goro; Ito, Rokusuke; and Okada, Shichiro; hereinafter referred to as an “approver 5”, an “approver 6” and “approver 7”, respectively) view and approve the “searcher instance 4” and each of them registers an approval incentive of 3,000 points. Still further, another member (Yamanaka, Hachiro; hereinafter referred to as an “approver 8”) views and approves the “searcher instances 2 and 3” and registers an approval incentive of 5,000 points. Another member (Kaiketsu, Kuro; hereinafter referred to as a “solver 9”) views the “searcher instances 2 and 4” and tries to propose a solution to participant instances for the instances 2 and 4.

As shown in FIG. 8, three searcher instances “searcher instances 2 to 4” are registered for the participant instance “instance 1”, and four approvers “approvers 5 to 8” add incentives to make the total incentive 17,000 points. In this manner, for a participant instance describing a more important problem, more members would be interested in the instance and a more detailed searcher instance and the like would be registered. Also, more members would seek solution proposals and raise an incentive to be provided.

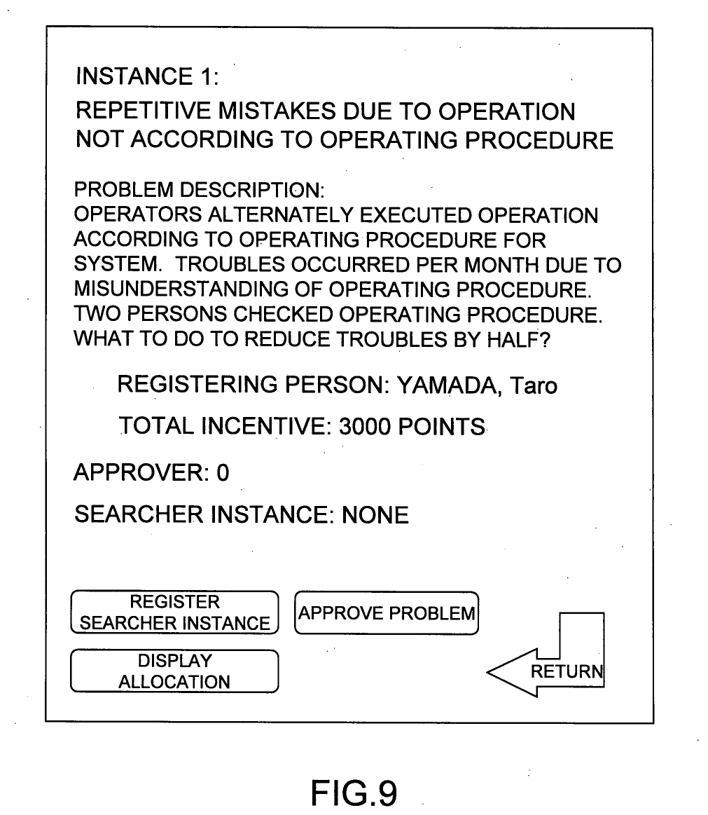

FIG. 9 is a diagram showing an example of a screen display for the participant instance registered by the participant 1. The exemplary screen display in FIG. 9 displays the participant 1 (a registering person) who inputted the participant instance, instance description describing the participant instance (problem description) and an incentive (the total incentive). The screen display for the participant instance further displays information of approvers or searcher instances registered for the participant instance if any. In that case, the total of the incentive and approval incentives is displayed as the total incentive. The screen display in FIG. 9 is an example of display before registration of the searcher instances “searcher instances 2 to 4” and the approval incentives by the four approvers 5 to 8.

The screen display in FIG. 9 further includes buttons: “Register Searcher Instance”, “Approve Problem”, “Display Allocation” and “Return”. When the button “Register Searcher Instance” is selected through a mouse click or the like, the instance and incentive registering unit 13 registers the searcher instance. When the button “Approve Problem” is selected, the instance and incentive registering unit 13 registers an approval incentive. When the button “Display Allocation” is selected, the incentive allocation calculating unit 17 calculates incentive allocation. When the button “Return” is selected, the display returns to the pre-determined top menu.

After the “instance 1” is registered in the instance database 11, the instance and incentive display unit 15 displays the screen display of the participant instance in FIG. 9 on the terminal 2 of the searcher 2 requesting to view the “instance 1”.

Once the searcher 2 views the participant instance and selects the button “Register Searcher Instance” in the screen display, the searcher instance register process starts. The inputted data is sent to the knowledge circulation assisting apparatus 1 via the network N. The instance and incentive registering unit 13 registers the searcher instance “searcher instance 2” in the instance database 11.

After the “searcher instance 2” is registered in the instance database 11, the instance and incentive display unit 15 displays the screen display of the “instance 1” with the registered “searcher instance 2” on the terminal 2 of the searcher 4 requesting to view the “instance 1”.

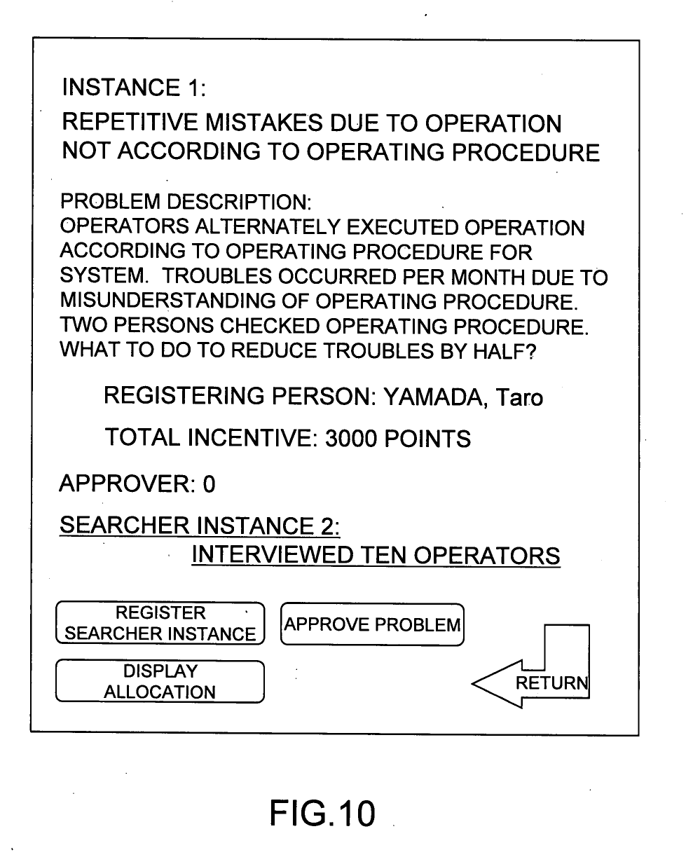

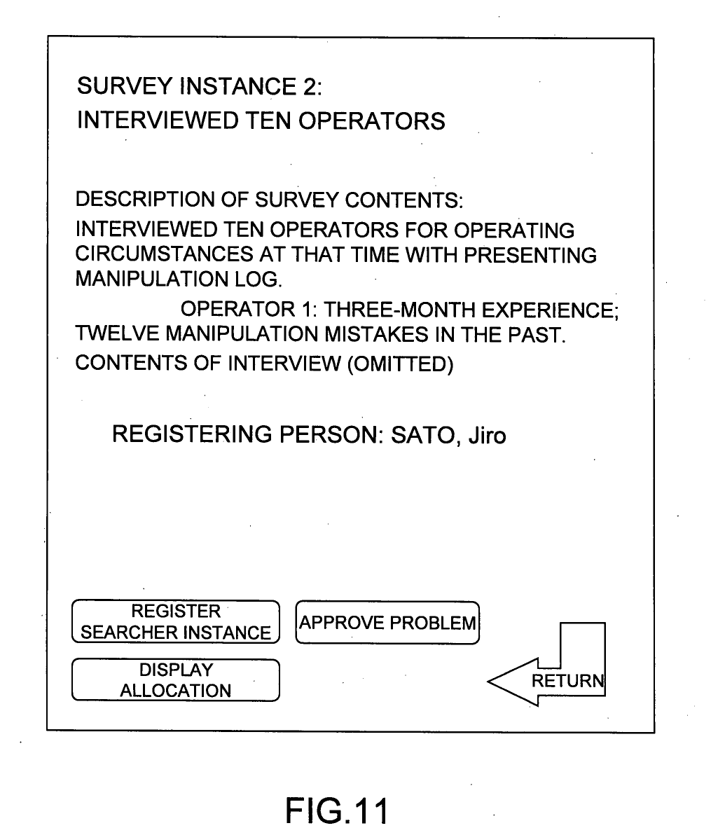

FIG. 10 is a diagram showing an example of a screen display for the participant instance “instance 1” with the registered searcher instance “searcher instance 2”. The screen display in FIG. 10 is approximately same as the exemplary screen display in FIG. 9. However, there is added “Searcher Instance 2: Interviewed ten operators” registered by the searcher 2. When the “searcher instance 2” is selected through a mouse click or the like in the screen display in FIG. 10, the instance and incentive display unit 15 displays the screen display of the “searcher instance 2”. FIG. 11 is a diagram showing an example of a screen display for the searcher instance “searcher instance 2”.

When a member, for example the approver 8, approving the “instance 1” and the “searcher instance 2” selects the button “Approve Problem” on the screen display in FIG. 10, the incentive raising process starts. The instance and incentive registering unit 13 associates the inputted approval incentive with the “instance 1” and then registers the incentive in the instance database 11.

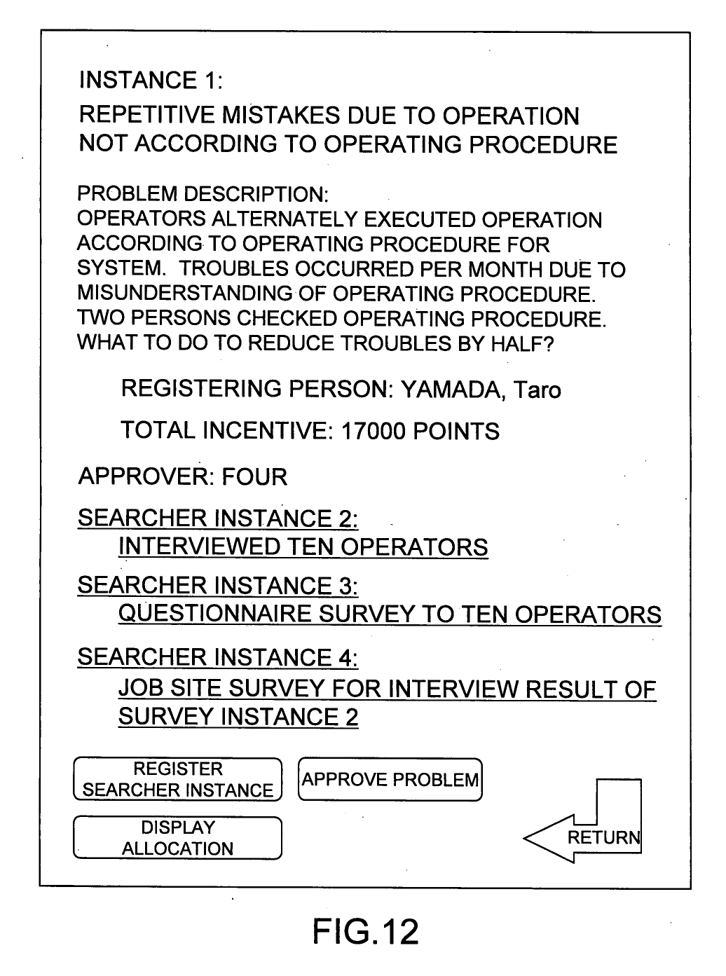

After the “searcher instances 3 and 4” and the approvers 5 to 8 are registered in the instance database 11 by repeating the above processes, the instance and incentive display unit 15 displays the screen display of the “instance 1” with the registered “searcher instances 2, 3 and 4” and the approvers 5 to 8 when a member requests display of the “instance 1”. FIG. 12 is a diagram showing an example of a screen display for the participant instance “instance 1” with the registered searcher instances and approvers.

Assume that the solver 9 selects and views the “searcher instances 2 and 4” through the screen display in FIG. 12 to think of a solution proposal, and desires to know an incentive to be given for the provision of the solution proposal before proposing the solution to the participant or approvers and discussing the contents. When the solver 9 selects the button “Display Allocation” through the screen display in FIG. 12, the incentive allocation calculating unit 17 references the instance database 11. Based on a viewing relation at that time, the unit 17 registers the solver 9 and the “searcher instances 2 to 4” and calculates incentive allocation to the searchers 2 to 4 according to the pre-determined calculating method.

The allocation calculation processing is done based on the above mentioned allocation calculating approaches (1) to (4). The multipliers of the weighting for the allocation are set to be a=3, b=0.5 and c=10.

An allocation rate of an incentive to a solver and the incentive to be provided are as follows:

Incentive rate for solver=3/(number of searchers+3)*100=50%;

Incentive to solver=17000*50%=8500;

Then, weighting for the incentive for approver acquisition and searcher acquisition is calculated. Allocation by weighting each of the searchers is as follows:

$$Allocation rate for searcher 2 ( incentive to be allocated ) = 50 \% * 8500 / ( 8500 + 35000 + 100000 ) = 3.0 \% ( 510 ) ;$$

$$Allocation rate for searcher 3 ( incentive to be allocated ) = 50 \% * 35000 / ( 8500 + 35000 + 10000 ) = 12.2 \% ( 2074 ) ;$$

$$Allocation rate for searcher 4 ( incentive to be allocated ) = 50 \% * 100000 / ( 8500 + 35000 + 100000 ) = 34.8 \% ( 5916 ) .$$

Consequently, the allocation ratio among the searchers is as follows:
searcher 2: searcher 3: searcher 4=8500: 3500: 10000

With the multiplier c=10 of weighting for the searchers 3 and 4 contributed to the solution, the allocation ratio among the searchers is as follows:
searcher 2: searcher 3: searcher 4=8500: 35000 (=3500*10): 100000 (=10000*10)

As a result, incentive allocation rates are as follows:

$$Allocation to searcher 4 = 9000 ( = total of incentives for approvers 5 to 7 ) + 3000 / 3 ( = incentive to participant 1 per searcher ) ;$$

$$Allocation to searcher 3 = 2500 ( = incentive to approver 8 * 1 / 2 ) + 3000 / 3 ( = incentive to participant 1 per searcher ) ;$$

$$Allocation to searcher 2 = 10000 * 0.5 ( = weighting for searcher 4 * a ) + 2500 ( = incentive to approver 8 * 1 / 2 ) + 3000 / 3 ( = incentive to participant 1 per searcher ) .$$

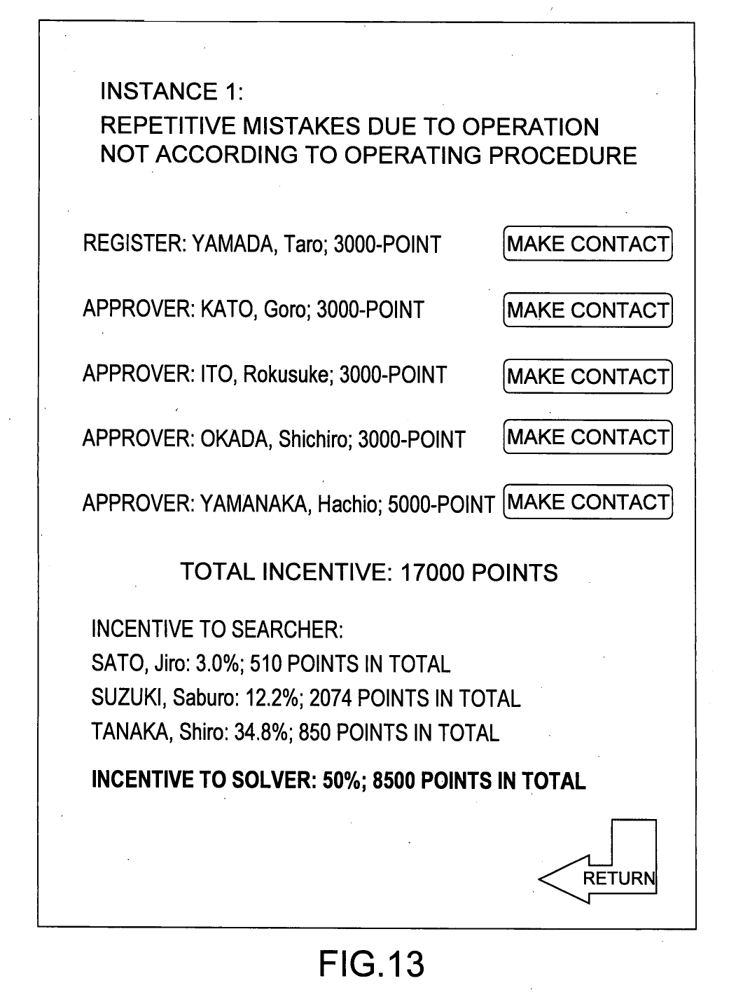

FIG. 13 is a diagram showing an example of a screen for displaying the incentive allocation. The screen display in FIG. 13 displays the registering person (participant) providing the incentive, the approvers, the incentives to them, the incentives allocated to the searchers, and the incentive allocated to the solver. The display further includes the “Contact” buttons to contact the registering person (participant) and the approvers. If the solver desires to discuss any of proposed solutions, he selects the “Contact” buttons for the registering person or the approvers to be contacted. The message notifying unit 19 sends a pre-determined message or a member-created message of text data to the terminals 2 of the selected participant member or approving members via the network N.

Although the present invention has been described in the above according to its embodiment, different variations can be made within the scope of the present invention. For example, although the process has been described when a solver requests display of incentive allocation in the above embodiment, individual members can request the display of the incentive allocation at their will, provided the incentive.

The present invention can also be realized as a program causing a computer to execute the above described process. The program can be stored in a relevant recording medium such as a computer-readable, portable medium memory, a semiconductor memory or a hard disk. The program can be recorded in such a recording medium for distribution, or can be distributed by transmission using various communication networks via communication interface.

What is claimed is:

1. A knowledge circulation assisting apparatus for assisting circulation of information for a knowledge database in which pre-determined members can retrieve the registered information as their knowledge, comprising:
a participant instance registering unit for registering a participant instance indicating a problem for which solution proposals are sought, an incentive to be provided to members involved in solution to the participant instance, and a member, as a participant, who registered the participant instance in the knowledge database;
a related information registering unit for associating information indicating an instance or intention to be involved to the participant instance and a member who registered the information relating to the participant instance, and registering the information and the member in the knowledge database;
an allocation calculating unit for retrieving an incentive and the member for the participant instance from the knowledge database, and calculating allocation of the incentive to members involved in the solution to the participant instance and one or more solvers among the pre-determined members based on a pre-determined rate; and
an incentive display unit for displaying the incentive allocation to the members including the solver who are involved in the solution to the participant instance.

2. The knowledge circulation assisting apparatus according to claim 1, wherein the related information registering unit comprises a searcher instance registering unit for associating a searcher instance indicating the information relating to the participant instance and one ore more members, as a searcher, who registered the searcher instance with the participant instance and registering the searcher instance and the searcher in the knowledge database;
the allocation calculating unit retrieves the incentive and the searcher for the participant instance from the knowledge database, and calculates the incentive allocation to the retrieved searcher and the solver based on the pre-determined rate; and
the incentive display unit displays the incentives to be allocated to the determined searcher and the solver.

3. The knowledge circulation assisting apparatus according to claim 1, wherein the related information registering unit comprises an approver registering unit for associating one or more members, as a approver, who approve the participant instance, and an approval incentive to be added to the incentive for the participant instance with the participant instance and registering the approver and the approval incentive in the knowledge database; and
the allocation calculating unit sums up the incentive and the approval incentive for the participant instance extracted from the knowledge database, and calculates allocation of the total incentive to the members involved in the solution to the participant instance.

4. The knowledge circulation assisting apparatus according to claim 2, wherein the searcher instance registering unit registers reference relations indicating searcher instances referenced by other members in the knowledge database; and
the allocation calculating unit identifies the reference relations of the searcher instances associated with the participant instance, weights the allocation rate based on the reference relations, and calculates the incentive allocation to the searchers of the referenced searcher instances by increasing the allocation using the weighting.

5. The knowledge circulation assisting apparatus according to claim 1 comprising a contact processing unit for storing contact information of the members who are involved in the participant instance, and notifying the contact-requested members of pre-determined messages.

6. A knowledge circulation assisting method for a computer to execute a process for assisting circulation of information for a knowledge database in which pre-determined members can retrieve the registered information as their knowledge, comprising:
a participant instance registering step of registering a participant instance indicating a problem for which solution proposals are sought, an incentive to be provided to members involved in solution to the participant instance, and a member, as a participant, who registered the participant instance in the knowledge database;
a related information registering step of associating information indicating an instance or intention to be involved to the participant instance, and a member who registered the information with the participant instance and registering the information and the member in the knowledge database;
an allocation calculating step of retrieving an incentive and the member for the participant instance from the knowledge database, and calculating allocation of the incentive to members involved in the solution to the participant instance and one or more solvers among the pre-determined members based on a pre-determined rate; and
an incentive display step of displaying the incentive allocation to the members and the solver involved in the solution to the participant instance.

7. The knowledge circulation assisting method according to claim 6, wherein the related information registering step comprises a searcher instance registering step of associating a searcher instance indicating the information relating to the participant instance, and one or more members, as a searcher, who registered the searcher instance with the participant instance and registering the searcher instance and the searcher in the knowledge database;
the allocation calculating step comprises retrieving the incentive and the searcher for the participant instance from the knowledge database, and calculating the incentive allocation to the retrieved searcher and the solver based on the pre-determined rate; and
the incentive display step comprises displaying the incentives to be allocated to the determined searcher and the solver.

8. The knowledge circulation assisting method according to claim 6, wherein the related information registering step comprises an approver registering step of associating one or more members, as a approver, who approve the participant instance, and an approval incentive added to the incentive for the participant instance with the participant instance and registering the approver and the approval incentive in the knowledge database; and
the allocation calculating step comprises summing up the incentive and the approval incentive for the participant instance extracted from the knowledge database, and calculating allocation of the total incentive to the members involved in the solution to the participant instance.

9. The knowledge circulation assisting method according to claim 7, wherein the searcher instance registering step further comprises registering reference relations indicating searcher instances referenced by other members in the knowledge database; and
the allocation calculating step comprises identifying the reference relations of the searcher instances associated with the participant instance, weighting the allocation rate based on the reference relations, and calculating the incentive allocation to the searchers of the referenced searcher instances by increasing the allocation using the weighting.

10. The knowledge circulation assisting method according to claim 6, comprising a contact processing step of storing contact information of the members involved in the participant instance, and notifying the contact-requested members of pre-determined messages.

11. A computer-readable recording medium storing a knowledge circulation assisting program for causing a computer to function as an apparatus for assisting circulation of information for a knowledge database in which pre-determined members can retrieve the registered information as their knowledge, the apparatus comprising:
a participant instance registering unit for registering a participant instance indicating a problem for which solution proposals are sought, an incentive to be provided to members involved in solution to the participant instance, and a member, as a participant, who registered the participant instance in the knowledge database;
a related information registering unit for associating information indicating an instance or intention to be involved to the participant instance and a member who registered the information relating to the participant instance, and registering the information and the member in the knowledge database;
an allocation calculating unit for retrieving an incentive and the member for the participant instance from the knowledge database, and calculating allocation of the incentive to members involved in the solution to the participant instance and one or more solvers among the pre-determined members based on a pre-determined rate; and
an incentive display unit for displaying the incentive allocation to the members including the solver who are involved in the solution to the participant instance.

12. The computer-readable recording medium according to claim 11, wherein the related information registering unit comprises a searcher instance registering unit for associating a searcher instance indicating the information relating to the participant instance and one ore more members, as a searcher, who registered the searcher instance with the participant instance and registering the searcher instance and the searcher in the knowledge database;
the allocation calculating unit retrieves the incentive and the searcher for the participant instance from the knowledge database, and calculates the incentive allocation to the retrieved searcher and the solver based on the pre-determined rate; and
the incentive display unit displays the incentives to be allocated to the determined searcher and the solver.

13. The computer-readable recording medium according to claim 11, wherein the related information registering unit comprises an approver registering unit for associating one or more members, as a approver, who approve the participant instance, and an approval incentive to be added to the incentive for the participant instance with the participant instance and registering the approver and the approval incentive in the knowledge database; and
the allocation calculating unit sums up the incentive and the approval incentive for the participant instance extracted from the knowledge database, and calculates allocation of the total incentive to the members involved in the solution to the participant instance.

14. The computer-readable recording medium according to claim 12, wherein the searcher instance registering unit registers reference relations indicating searcher instances referenced by other members in the knowledge database; and
the allocation calculating unit identifies the reference relations of the searcher instances associated with the participant instance, weights the allocation rate based on the reference relations, and calculates the incentive allocation to the searchers of the referenced searcher instances by increasing the allocation using the weighting.

15. The computer-readable recording medium according to claim 11 comprising a contact processing unit for storing contact information of the members who are involved in the participant instance, and notifying the contact-requested members of pre-determined messages.
